(19) United States
(12) Patent Application Publication
(10) Pub. No.: US 2020/0250013 A1
(43) Pub. Date: Aug. 6, 2020

(54) APPLICATIONS PROGRAM INTERFACE (API) GATEWAY

(71) Applicant: salesforce.com, Inc., San Francisco, CA (US)

(72) Inventors: Christopher David Boran, San Francisco, CA (US); Jeremiah David Brazeau, San Francisco, CA (US)

(73) Assignee: salesforce.com, Inc., San Francisco, CA (US)

(21) Appl. No.: 16/263,946

(22) Filed: Jan. 31, 2019

(51) Int. Cl. G06F 9/54; H04L 29/06

(52) U.S. Cl. CPC G06F 9/54; H04L 65/102

(57) ABSTRACT

A micro-services architecture is provided supporting responses to client requests routed from client digital data devices to micro-servers via an API gateway. The gateway performs selective processing on the API requests after return from the micro-servers but before return to the client devices. This can be done without any a priori knowledge by either the client devices or the micro-servers of whether and how such processing is provided. It has the additional benefit of facilitating uniformity of responses to client requests by disparate micro-servers.

### BACKGROUND

Enterprise portals that support micro-services utilize applications program interface (API) gateways to route client requests to the micro-servers that provide those services. Routing is typically based on the pathway component of the request.

Thus, for example, an API gateway that provides the front-end, say, of the enterprise site xyz.com, may route browser requests addressed to xyz.com/support to one micro-services server (a/k/a “API server” or “micro-server”) hosted by the enterprise, while routing those addressed to xyz.com/orders to another of the enterprise's micro-services servers. Routing decisions are typically made based on lookup tables or other metadata local to the API gateways.

Although micro-services architectures can offer advantages over monolithic web services frameworks, there are disadvantages, as well. For example, micro-service architectures may fail to provide uniformity of responses to client requests.

### BRIEF DESCRIPTION OF THE DRAWINGS

A more complete understanding of the illustrated embodiment may be attained by reference to the drawings, in which:

FIG. 1 depicts an environment in which the illustrated embodiment is practiced;

FIG. 2 depicts the transfer and processing of request and responses in the environment of FIG. 1; and

FIG. 3 depicts further processing of request and responses in the environment of FIG. 1.

### DETAILED DESCRIPTION OF THE ILLUSTRATED EMBODIMENT

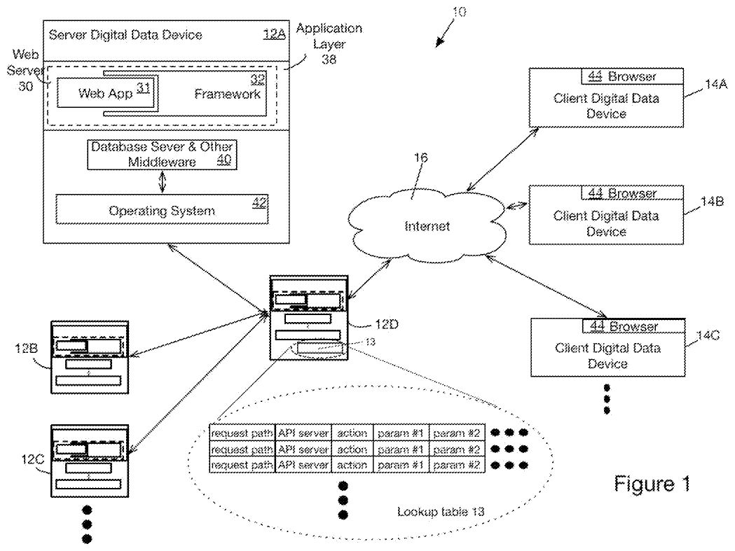

FIG. 1 depicts a digital data processing system 10 of the type providing an environment in which an embodiment is employed. The system 10 includes a plurality of micro-services servers (alternatively, herein, “micro-servers”, “servers” or “API servers”) 12A-12C that are coupled to one another and to client digital data devices (“clients”) 14A-14C via a network 16. An applications program interface (API) gateway 12D is disposed on the network between the servers 12A-12C and clients 14A-14C, as shown, as per convention in a micro-services architecture of the type used in support of a web site, web portal or other web services.

Together, devices 12A-12D comprise a micro-services architected digital data processing system that supports an e-commerce site of an online retailer and clients 14A-14C are digital devices (e.g., smart phones, desktop computers, and so forth) of users of that site. In other embodiments, devices 12A-12D may support a web site storing and/or otherwise providing access to other content, instead or in addition.

Devices 12A-12D, 14A-14C comprise conventional digital data devices of the type available in the marketplace suitable for adaptation (and so adapted) to the roles ascribed to the respective devices herein.

Thus, for example, devices 12A-12C comprise conventional minicomputers, micro-servers or other server-class digital data devices suitable for use as micro-servers and so adapted in accord with the teachings hereof. Device 12D likewise comprises a conventional programmable network gateway, a networked minicomputer or other server-class device suitable for use as an API gateway and so adapted in accord with the teachings hereof.

Devices 12A-12D may be of the same type, though, more typically, they constitute a mix of devices of differing types, depending on how they are purposed in accord with the teachings hereof. And, although only a single API gateway 12D and three micro-servers 12A-12C are depicted and described here, it will be appreciated that other embodiments may utilize differing numbers of these devices to perform the functions ascribed thereto herein.

By way of further example, devices 14A-14C comprise desktop computers, workstations, laptop computers, tablet computers, PDAs, mobile phones or other digital data devices of the type that are commercially available in the marketplace suitable for use as client devices, all as adapted in accord with the teachings hereof. Although three client devices 14A-14C are shown, it will be appreciated that other embodiments may utilize a greater or lesser number of those devices, homogeneous, heterogeneous or otherwise.

One or more of devices 12A-12D and 14A-14C may be configured as and/or to provide database systems (including, for example, a multi-tenant database system) or other systems or environments. And, although shown here in a client-server architecture, the devices 12A-12D, 14A-14C may be arranged to interrelate in a peer-to-peer, client-server or other architecture and/or protocol consistent with the teachings hereof.

Per convention, each of devices 12A-12D and 14A-14C comprise central processing, memory, and input/output subsections (not shown here) of the type known in the art and suitable for (i) executing software suitable for purposing those devices in accord with their respective functions herein and/or known in the art (e.g., applications software, operating systems, and/or middleware, as applicable) as adapted in accord with the teachings hereof and (ii) communicating over network 16 to other devices 12A-12D, 14A-14C in the conventional manner known in the art as adapted in accord with the teachings hereof.

Examples of such software (shown, here, executing on micro-server 12A, but suitable for execution on all of devices 12A-12D as suitably configured in accord with the teachings hereof) include web server 30 that responds to requests in HTTP or other protocols received via network 16 (e.g., from clients 14A-14C in the case of gateway 12D; and, from gateway 12D in case of micro-servers 12A-12C) for transferring web pages, downloads and other digital content to the requesting device over network 16, in the conventional manner known in the art as adapted in accord with the teachings hereof.

In the illustrated embodiment, web server 30 comprises web application 31 executing on device 12 within and/or in connection with a web application framework 32. Web application 31 comprises conventional such software known in the art (as adapted in accord with the teachings hereof) for effecting specific behavior by the server 12 in response to incoming requests.

In the case of a micro-server 12A-12C whose function is to serve product information, by way of non-limiting example, web application 31 responds to requests for information on products by returning that information (as obtained from on-board stores or otherwise, not shown), e.g., via web pages, downloads or other output, to a requesting device, e.g., in cooperation with framework 32 and other components of the respective server 12; all per convention in the art as adapted in accord with the teachings hereof.

In the case of a micro-server 12A-12C whose function is to provide customer support, by way of further example, web application 31 responds to requests for assistance by establishing dialogs (automated or otherwise) with requesting client devices 14A-14C (here, typically, via gateway 12D) and, more particularly, for example, the users thereof, e.g., for purposes of identifying and resolving customer requests, e.g., via interactive web pages, downloads and the like, again, in cooperation with framework 32 and other components of the respective server 12 and, again, all per convention in the art as adapted in accord with the teachings hereof.

In the case of API gateway 12D, by way of still further example, web application 31 responds to representational state (REST) requests, e.g., from client devices 14A-14C, directed to a given domain (e.g., xyz.com) by forwarding those requests to respective ones of the micro-servers 12A-12C for that domain and processing, for return in REST responses to the respective requesting clients 14A-14C, data in the responses returned from the micro-servers. To this end, the gateway 12D wraps or other suitably modifies those requests (including, for example, altering a protocol of the request) to insure that they are returned by targeted micro-server 12A-12C to the gateway 12D, once processing is completed.

In embodiments where the requests are in accord with the HTTP protocol, routing of the requests to the micro-servers can be based on a pathway component of the destination URL provided with the request, metadata or other information in the packet header of the request, or otherwise, as per convention in the art, as adapted in accord with the teachings hereof. Such routing decisions can be based on a lookup table, metadata or otherwise, as per convention in the art, as adapted in accord with the teachings hereof.

Such a lookup table 13, shown by way of non-limiting example in FIG. 1, can include rows that associate a pathway in the request (“request path”) with a respective micro-server 12A-12C, as well as with an action specifying the processing to perform on data in responses received from the micro-server after it has processed the request (“action”) and parameters to be used in performing that action “param #1,” “param #2,” and so forth. One row of the table 13 of a gateway 12D assigned to the domain (e.g., xyz.com), by way of example, might specify that requests with a URL pathway “xyz.com/support” are to be directed to micro-server 12A, while those with a URL pathway “xyz.com/orders” are to be directed to micro-server 12B, and so forth; all per convention in the art as adapted in accord with the teachings hereof.

Web framework 32 comprises conventional such software known in the art (as adapted in accord with the teachings hereof) providing libraries and other reusable services that are (or can be) employed by one and/or a variety of web applications of the type used in microservers and/or API gateways.

In the illustrated embodiment, web server 30 and its constituent components, web application 31 and web application framework 32, execute within an application layer 38 of the server architecture. That layer 38, which provides services and supports communications protocols in the conventional manner known in the art as adapted in accord with the teachings hereof, can be distinct from other layers in the server architecture—layers that provide services and, more generally, resources (a/k/a “server resources”) that are required by the web application 31 and/or framework 32 in order to process at least some of the requests received by server 30 from clients 14A-14C. Those other layers include, for example, a data layer that provides services supporting interaction with a database server 40 (that interfaces with storage 41 for purposes of storing information thereto and/or retrieving information therefrom in the conventional manner known in the art as adapted in accord with the teachings hereof) and the server's operating system 42 (which manages the server hardware and software resources and provides common services for software executing thereon in the conventional manner known in the art as adapted in accord with the teachings hereof). Other embodiments may utilize an architecture with a greater or lesser number of layers and/or with layers providing different respective functionalities than those illustrated here.

Though described herein in the context of a web server 30, in other embodiments applications 31 and 32 of microservers 12A-12C may define other functionality suitable for responding to requests, e.g., a video server, a music server, or otherwise. And, though shown and discussed here as comprising web application 31 and web framework 32, in other embodiments, the web server 30 of any of devices 12A-12D may combine the functionality of illustrated components 31 and 32 in a single component or distribute it among still more components.

Devices 12A-12D can be architected similarly to one another, although this is not a requirement. Thus, each may comprise a special-purpose architecture and software suitable to its function as a microserver (in the case of devices 12A-12C) and as an API gateway (in the case of device 12D).

With continued reference to FIG. 1, client devices 14A-14C of the illustrated embodiment execute web browsers 44 that typically operate under user control to generate requests in HTTP or other protocols, e.g., to request web pages displaying information on products accessible via the site supported by devices 12A-12D, to request customer assistance, and so forth, and to transmit those requests to web server 30 over network 14—all in the conventional manner known in the art as adapted in accord with the teachings hereof. Though referred to here as web browsers, in other embodiments applications 44 may comprise web apps or other functionality suitable for transmitting requests to a server 30 and/or presenting content received therefrom in response to those requests.

Network 16 comprises one or more networks suitable for supporting communications between devices 12A-12D and client device 14A-14C. The network comprises one or more arrangements of the type known in the art, e.g., local area networks (LANs), wide area networks (WANs), metropolitan area networks (MANs), and or Internet(s). Although a client-server architecture is shown in the drawing, the teachings hereof are applicable to digital data devices coupled for communications in other network architectures.

As those skilled in the art will appreciate, the “software” referred to herein—including, by way of non-limiting example, browsers 44, web servers 30 and their constituent components, web application 31 and web application framework 32—comprise computer programs (i.e., sets of computer instructions) stored on transitory and non-transitory machine-readable media of the type known in the art as adapted in accord with the teachings hereof, which computer programs cause the respective digital data devices, e.g., 12A-12D and 14A-14C to perform the respective operations and functions attributed thereto herein. Such machine-readable media can include, by way of non-limiting example, hard drives, solid state drives, and so forth, coupled to the respective digital data devices 12A-12D and 14A-14C in the conventional manner known in the art as adapted in accord with the teachings hereof.

Discussed below is operation of API gateway 12D, in response to requests received from client devices 14A-14C and responses to those requests by micro-servers 12A-12C. Such operation is attributed, in the discussion, to “gateway 12D,” though in practice it may be effected by web application 31 of API gateway 12D working in cooperation with framework 32 and the other components of device 12D and 30, as well as with API servers 12A-12C and browsers 44 and other components of client devices 14A-14C, all in the conventional manner known in the art as adapted in accord with the teachings hereof.

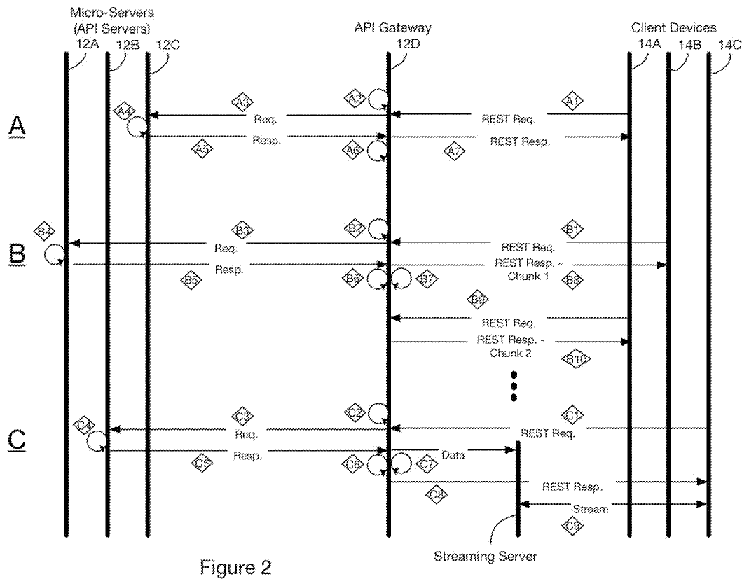

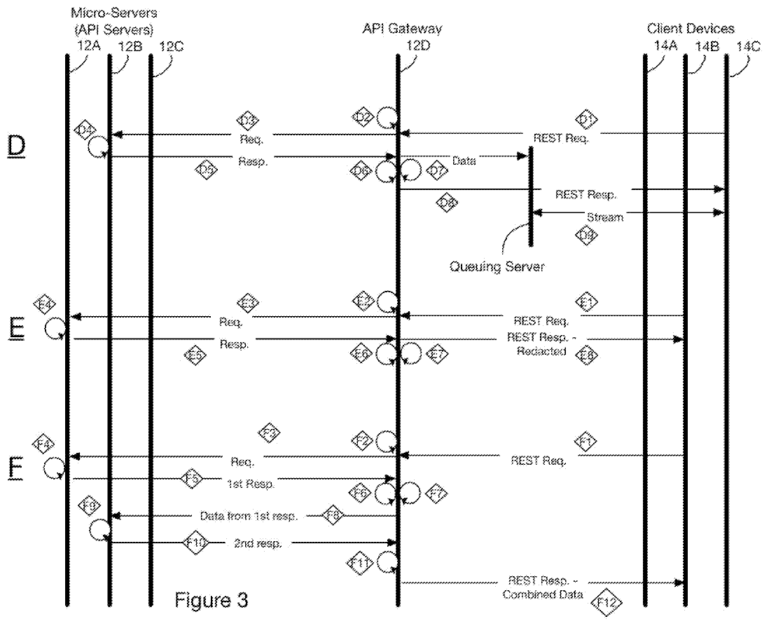

FIGS. 2-3 depict the transfer and processing of requests and responses during exemplary transactions between client devices 14A-14C, gateway 12D and micro-servers (API servers) 12A-12C in system 10. For example, in transaction A, client 14A transmits a REST HTTP request (via network 16) to the domain of the site supported by devices 12A-12D. Step A1. Gateway 12D, which is designated through the DNS system in the conventional manner as the recipient of requests designated to that domain, receives client 14A's request via network 16 in the conventional manner.

In step A2, gateway 12D determines which micro-server 12A-12C to forward the request to. In the illustrated embodiment, that determination is made by comparing the pathway component of the address portion of the request packet against the “request path” field of rows in lookup table 13, with the “API server” field of the matching row of the table providing the address of the target micro-server 12A-12C. Alternate embodiments can use metadata provided in the request packet or other techniques within the ken of those skilled in the art to determine the target micro-server address from the request packet pathway. Regardless, the gateway wraps or otherwise modifies the request packet for routing over network 16 (step A3) to the designated micro-server (server 12C in the example for transaction A) and so that a response packet generated by that microserver is returned to gateway 12D for further processing as necessary.

In step A4, the designated micro-server 12C processes the wrapped request packet per convention in the art to generate a response packet, which it transmits on network 16. Step A5. As a benefit of the architecture and operation of the illustrated embodiment, such processing by micro-server 12C is without “knowledge” or contemplation of any processing that the gateway 12D might perform on data generated by micro-server 12C for including in the response packet.

In step A6, upon receipt of the response packet, gateway 12D determines whether and what type of processing is required on data in the response packet before its transmission to the requesting client 14A. In the illustrated embodiment, that determination is made by comparing the address of the device originating the response (here, micro-server 12C) against the “API server” field of rows in lookup table 13, with the “action” field of the matching row of the table specifying what action, if any, to take on data contained in the response packet. (As will be appreciated, this is tantamount to the comparison in step A2, comparing the pathway component of the original request packet against the “request path” field of rows of that same table). Alternate embodiments can use metadata in the response packet header (or otherwise) or other techniques within the ken of those skilled in the art to determine what processing is required on the response packet based on its source. If no action is required, as indicated with respect to the example of transaction A, the packet is routed to the requesting client (here, client 14A) as a REST response packet, wrapped or modified as necessary to identify it as a response to the request originated by that client in step A1. See, step A7.

Transaction B of FIG. 2 illustrates operation of the gateway 12D in “chunking” of data in the response generated by a micro-server before it is returned to the requesting client. Chunking, as per convention in the art, refers to the grouping and transmission of subsets of information. It can be used, by way of non-limiting example, to break up a response data packet that includes, say, ten or hundreds of web pages, of information into multiple packets of, say, 10 web pages (or subsets or “chunks”) of information each.

Transaction B parallels transaction A from step B1 through Step B6. Thus, step B1 parallels step A1, step B2 parallels step A2, and so forth, through step B6 (which parallels step A6)—except, insofar as (i) the request packet in step B1 is generated by client 14B and includes a destination address with a path that matches a different row in table 13 and, hence, is routed by gateway 12D to a different micro-server (here, micro-server 12A), whence the response packet is generated and transmitted in steps B4 and B5, and (ii) in step B6, the gateway “action” field of the table row whose “API server” field matches the address of the response originator (here, micro-server 12A) indicates that the response is to be chunked.

In step B7, the gateway 12D processes data in the response packet by identifying the first chunk of it (e.g., continuing the example above, the first 10 web pages) and generating a REST response packet including that chunk. The gateway can also modify the packet by including a hypertext link, widget, or other element that, when actuated by the client device, will generate a request for a further packet from the remaining chunks. Gateway 12D stores data for those remaining chunks in local storage (not illustrated) until requested and, in step B8, transfers the response packet with the first chunk to the requesting client device 14B.

Upon user or other actuation of the aforesaid link, widget or other element in the packet transmitted to it in step B8, a further request is transmitted from the client 14B to gateway 12D. See step B9. The gateway can respond by generating a further response packet in the manner described above vis-à-vis step B7, albeit with the next successive chunk of data, transmitting that response in step B10, as indicated.

This sequence can be repeated until the gateway 12D has transmitted to the requesting client 14B chunks comprising all data received by gateway 12D in the response packet generated by micro-server 12A in steps B4 and B5.

Transaction C of FIG. 3 illustrates operation of the gateway 12D in the streaming of data in a response generated by a micro-server before it is returned to the requesting client.

Transaction C parallels transaction B from step C1 through Step C7. Thus, step C1 parallels step B1, step C2 parallels step B2, and so forth, through step C6 (which parallels step B6)—except, insofar as (i) the request packet in step C1 is generated by client 14C and includes a destination address with a path that matches a different row in table 13 and, hence, is routed by gateway 12D to a different micro-server (here, micro-server 12B), whence the response packet is generated and transmitted in steps C4 and C5, (ii) in step C6, the gateway “action” field of the table row whose “API server” field matches the address of the response originator (here, micro-server 12A) indicates that the response is to be streamed and the parameters of that row specify the identity or other characteristics of the streaming server to use.

In step C7, the gateway 12D processes data in the response packet by transferring it to the specified streaming server, if any, or another server suitable for such purpose, which may be co-housed with the gateway 12D or on another digital device associated with the site supported by devices 12A-12D, or otherwise. In step C8 the gateway 12D generates and transmits to the requesting client 14C a REST response packet including a link to the streaming server and the address of the data thereon. The client device 14C (or the user thereof) can activate that link to effect streaming of the requested data from the streaming server in the conventional manner known in the art as adapted in accord with the teachings hereof.

Transaction D of FIG. 3 illustrates operation of the gateway 12D in the queuing of data in the response generated by a micro-server before it is returned to the requesting client.

Illustrated transaction D parallels transaction C from step D1 through Step D9. Thus, step D1 parallels step C1, step D2 parallels step C2, and so forth, through step D9 (which parallels step C9)—except, insofar as (i) in step D6, the gateway “action” field of the table row whose “API server” field matches the address of the response originator (here, micro-server 12B) indicates that the response is to be queued and the parameters of that row specify the identity or other characteristics of the queuing server to use, and (ii) in step D7, the gateway 12D processes data in the response packet by transferring it to the parameter-specified server, if any, or another server suitable for queuing the data (i.e., holding it) until requested by the client device 14C (that “queuing” server may be co-housed with the gateway 12D or on another digital device associated with the site supported by devices 12A-12D, or otherwise), and (iii) in step D8 the gateway 12D generates and transmits to the requesting client 14C a REST response packet including a link to the queuing server and the address of the data thereon.

The client device 14C (or the user thereof) can activate that link to effect download or other transfer of the requested data from the queuing server in the conventional manner known in the art as adapted in accord with the teachings hereof.

Transaction E of FIG. 3 illustrates operation of the gateway 12D in the redacting or removing data from the response generated by a micro-server before that response is returned to the requesting client. This can be effected, for example, to prevent transmission of sensitive data.

Transaction E parallels transaction A from step E1 through Step E6. Thus, step E1 parallels step A1, step E2 parallels step A2, and so forth, through step E6 (which parallels step A6)—except, insofar as (i) the request packet in step E1 is generated by client 14B and includes a destination address with a path that matches a different row in table 13 and, hence, is routed by gateway 12D to a different micro-server (here, micro-server 12A), whence the response packet is generated and transmitted in steps E4 and E5, and (ii) in step E6, the gateway “action” field of the table row whose “API server” field matches the address of the response originator (here, micro-server 12A) indicates that sensitive data is to be redacted/removed from the response. Parameters in that matching row can specify by field name, regular expression pattern or otherwise, data that is to be removed and/or redacted. Those parameters can also provide white and/or black lists of IP addresses of client devices for which such redaction is to be performed.

In step E7, the gateway 12D processes data in the response packet by removing or redacting data in the response in accord with those parameters. The gateway 12D then generates a REST response packet including that resulting data set and transmits it on network 16 for receipt by requesting client 14B. Step E8.

Transaction F of FIG. 3 illustrates operation of the gateway 12D in inhibiting the forwarding of data to a client device from a response received from an API server to a first request first until one or more responses are received from the API server(s) 12A-12C to other requests. This can be useful for consolidating data from multiple server responses and/or insuring that a requesting client device does not receive (and display or otherwise act on) data received from one API server until it (the client device) can receive all necessary data.

Transaction F parallels transaction A from step F1 through Step F6. Thus, step F1 parallels step A1, step F2 parallels step A2, and so forth, through step F6 (which parallels step A6)—except, insofar as (i) the request packet in step F1 is generated by client 14B and includes a destination address with a path that matches a different row in table 13 and, hence, is routed by gateway 12D to a different micro-server (here, micro-server 12A), whence the response packet is generated and transmitted in steps F4 and F5, and (ii) in step F6, the gateway “action” field of the table row whose “API server” field matches the address of the response originator (here, micro-server 12A) indicates that data in the response is to be processed in accord with instructions encoded, by way of a scripting language or otherwise, in parameters of that matching row.

For present purposes and by way of non-limiting example, those parameters can provide, e.g., that the data from micro-server 12A is to be routed to a specified second micro-server for processing and that, only after that processing is completed, should the data from the first micro-server (e.g., 12A) and that in the response from the second micro-server be returned to the requesting client device in a single response packet. Additional parameters in the row matched in step F6 can specify further requirements of the processing to be performed. Continuing the example, those parameters can identity of the (second) micro-server which is to be used to perform additional processing on the results returned from the first micro-server, the manner in which the result of both micro-servers should be combined (mathematically, textually or otherwise), and so forth, all as within the ken of those skilled in the art in view of the teachings hereof.

In accord with this example, in step F7, gateway 12D processes the script or other instructions in the parameter field of the matching row of table 13 and, in step F8, generates and transmits to the specified second micro-server (e.g., 12B) data from the response packet received from micro-server 12A in step F5.

In step F9, micro-server 12B processes the data received in step F8 per convention in the art to generate a response packet, which it transmits on network 16. Step F10. As a benefit of the architecture and operation of the illustrated embodiment, such processing by micro-server 12C is without “knowledge” or contemplation of any processing that the gateway 12D might perform on data generated by micro-server 12C for inclusion in the response packet.

Upon receipt of the response packet from the second micro-server (12B), gateway 12D processes the data in it in continued accord with the script or other instructions identified in step F6. Thus, continuing the example above, the gateway 12D can generate a response REST packet containing the data received in steps F5 (from the first micro-server 12A) and F10 (from the second micro-server 12B), possibly, combining that data as specified in the script or other instructions. See step F11. The gateway 12D transmits that packet to the requesting client device 14B in step F12.

Described above is the operation API of gateway 12D in response to requests received from client devices 14A-14C, including, the processing of data received from micro-servers 12A-12C in response to those requests. Such processing by the gateway 12D can be done without any a priori knowledge by either the client devices or the micro-servers of whether and how such processing is provided. It has the additional benefit of facilitating uniformity of responses to client requests by disparate micro-services servers.

It will be appreciated, moreover, that such processing is not limited to the types shown in transactions A-F discussed above and shown in the drawings, but can include combinations of two or more of those transactions (e.g., chunking data per transaction A in combination with redacting data per transaction E), as well as additional transactions and modes of data processing, as governed by parameters in table 13 or otherwise, all as is within the ken of those skilled in the art as adapted in accord with the teachings hereto.

It will additionally be appreciated, that such processing can include delaying the transmission and/or processing of packets and/or data, in accord with parameters of table 13 or otherwise, for purposes of throttling data throughput, again, as is within the ken of those skilled in the art in view of the teachings hereof.

Embodiments described here and shown in the drawings are merely examples, and that other embodiments fall within the scope of the claims that follow.

In view of the foregoing, what we claim is:

1. A method of operating an applications program interface (API) gateway, comprising the steps of
receiving from a client digital device, a request having an address directed to a host comprising a plurality of applications program interface (API) servers, the request being a representational state (REST) call to an API of the host,
routing the received request to a selected resource of the host, the routing selection being based on a pathway component of the address,
receiving, from the selected resource, a response to the request,
selectively processing data in the response, the processing including processing the data for further transfer, the selection for processing being based on any of
the resource from which the response was received,
the pathway component of the request in response to which that response was generated, and
metadata in the header of the request in response to which that response was generated,
generating and transmitting to the client device a REST response including the processed data.

2. The method of claim 1, the selective processing step including chunking the data, and the generating and transmitting step including generating and transmitting one or more respective chunks of the data to the client device in response to the request and one or more subsequent requests.

3. The method of claim 1, the selective processing step including configuring the data to be streamed, and the generating and transmitting step including generating and transmitting to the client device an address of a streaming source.

4. The method of claim 1, the selective processing step including queuing the data, and the generating and transmitting step including generating and transmitting to the client device an address of the queue.

5. The method of claim 1, the selective processing step including removing from the data information for which the client digital data device is not authorized

6. The method of claim 1, including selectively inhibiting the generating and transmitting step with respect to a response to a first said request, the selection for inhibiting being based on a response of one or more of the API servers to a second said request.

7. The method of claim 1, the selective processing step including combining data received from a said API server in response to a first request with data received from a said API server in response to a second request.

8. The method of claim 1, comprising selectively inhibiting any of the receiving and routing steps in order to throttle a rate of processing of requests by any of the API gateway and the API servers.

9. The method of claim 1, the selection for processing being based on metadata provided in headers of the response.

10. The method of claim 9, comprising matching, against a lookup table, any of the resource from which the response was received,
the pathway component of the request in response to which that response was generated.

11. The method of claim 1, at least one of the request and responses being received and/or generated in accord with an HTTP protocol.

12. The method of claim 1, including two or more of step sequences (i)-(vii) as set forth below:
i. the selective processing step including chunking the data, and the generating and transmitting step including generating and transmitting one or more respective chunks of the data to the client device in response to the request and one or more subsequent requests;
ii. the selective processing step including configuring the data to be streamed, and the generating and transmitting step including generating and transmitting to the client device an address of a streaming source;
iii. the selective processing step including queuing the data, and the generating and transmitting step including generating and transmitting to the client device an address of the queue;
iv. the selective processing step including removing from the data information for which the client digital data device is not authorized;
v. selectively inhibiting the generating and transmitting step with respect to a response to a first said request, the selection for inhibiting being based on a response of one or more of the API servers to a second said request;
vi. the selective processing step including combining data received from a said API server in response to a first request with data received from a said API server in response to a second request; and,
vii. selectively inhibiting any of the receiving and routing steps in order to throttle a rate of processing of requests by any of the API gateway and the API servers.

13. Computer instructions configured to cause an applications program interface (API) gateway to perform the steps of:
receiving from a client digital device, a request having an address directed to a host comprising a plurality of applications program interface (API) servers, the request being a representational state (REST) call to an API of the host,
routing the received request to a selected resource of the host, the routing selection being based on a pathway component of the address,
receiving, from the selected resource, a response to the request,
selectively processing data in the response, the processing including processing the data for further transfer, the selection for processing being based on any of
the resource from which the response was received
the pathway component of the request in response to which that response was generated, and
metadata in the header of the request in response to which that response was generated,
generating and transmitting to the client device a REST response including the processed data.

14. The computer instructions of claim 13 configured to cause the API gateway to perform the selective processing step to include chunking the data, and to cause the generating and transmitting step to include generating and transmitting one or more respective chunks of the data to the client device in response to the request and one or more subsequent requests.

15. The computer instructions of claim 13 configured to cause the API gateway to perform the selective processing step to include configuring the data to be streamed, and to cause the generating and transmitting step to include generating and transmitting to the client device an address of a streaming source.

16. The computer instructions of claim 13 configured to cause the API gateway to perform the selective processing step to include queuing the data, and to cause the generating and transmitting step to include generating and transmitting to the client device an address of the queue.

17. The computer instructions of claim 13 configured to cause the API gateway to perform the selective processing step to include removing from the data information for which the client digital data device is not authorized.

18. A machine readable storage medium having stored thereon a computer program configured to cause an applications program interface (API) gateway to perform the steps of:
receiving from a client digital device, a request having an address directed to a host comprising a plurality of applications program interface (API) servers, the request being a representational state (REST) call to an API of the host,
routing the received request to a selected resource of the host, the routing selection being based on a pathway component of the address,
receiving, from the selected resource, a response to the request,
selectively processing data in the response, the processing including processing the data for further transfer, the selection for processing being based on any of
the resource from which the response was received,
the pathway component of the request in response to which that response was generated, and
metadata in the header of the request in response to which that response was generated,
generating and transmitting to the client device a REST response including the processed data.

19. The machine readable storage medium of claim 18 having stored thereon a computer program configured to cause the API gateway to perform the selective processing step to include chunking the data, and to cause the generating and transmitting step to include generating and transmitting one or more respective chunks of the data to the client device in response to the request and one or more subsequent requests.

20. The machine readable storage medium of claim 18 having stored thereon a computer program configured to cause the API gateway to perform the selective processing step to include configuring the data to be streamed, and and to cause the generating and transmitting step to include generating and transmitting to the client device an address of a streaming source.

21. The machine readable storage medium of claim 18 having stored thereon a computer program configured to cause the API gateway to perform the selective processing step to include queuing the data, and to cause the generating and transmitting step to include generating and transmitting to the client device an address of the queue.

22. The machine readable storage medium of claim 18 having stored thereon a computer program configured to cause the API gateway to perform the selective processing step to include removing from the data information for which the client digital data device is not authorized.

23. A digital data processing system comprising,
a plurality of client digital devices generating and transmitting, on a network, requests having addresses directed to a common host, the host comprising a plurality of applications program interface (API) servers, each request being a representational state (REST) call to an API of the host,
an API gateway that is coupled to the network and to the API servers, the API gateway routing the requests to respective API servers of the host based on pathway components of the addresses of those requests,
each API server responding to a respective request received from the API gateway with a response that includes data generated as a function the API call in that request,
the API gateway selectively processing the responses received from the API servers, the processing including processing the data for further transfer, the selection for processing being based on any of
the resource from which the response was received,
the pathway component of the request in response to which that response was generated, and
metadata in the header of the request in response to which that response was generated,
the API gateway generating and transmitting to the respective client devices REST responses including the processed data.

24. The system of claim 23, the API gateway processing the data by chunking it, and the API gateway generating and transmitting one or more respective chunks of the chunked data to a said client device in response to a said request by it and one or more subsequent requests by it.
